(19) United States
(12) Patent Application Publication
(10) Pub. No.: US 2014/0358871 A1
(43) Pub. Date: Dec. 4, 2014

(54) DEDUPLICATION FOR A STORAGE SYSTEM

(71) Applicant: International Business Machines Corporation, Armonk, NY (US)

(72) Inventors: Roy D. Cideciyan, Rueschlikon (CH); Jens Jelitto, Rueschlikon (CH); Slavisa Sarafijanovic, Adliswil (CH); Jan Stanek, Wadenswil (CH)

(73) Assignee: INTERNATIONAL BUSINESS MACHINES CORPORATION, Armonk, NY (US)

(21) Appl. No.: 14/282,425

(22) Filed: May 20, 2014

(30) Foreign Application Priority Data
May 28, 2013 (GB) 1309484.2

(51) Int. Cl. G06F 17/30

(52) U.S. Cl. CPC G06F 17/30156
USPC 707/692

(57) ABSTRACT

A method and system for deduplication of data to be stored on a storage system. A deduplication system performs a method that includes the steps of: segmenting a storage object into a plurality of data segments; generating a content similarity key indicative of a content of a data segment as well as associating a physical position on the storage medium for the data segment with the generated content similarity key; storing the association in deduplication index information; and using the stored associations for optimizing the deduplication.

### CROSS-REFERENCE TO RELATED APPLICATION

This application claims priority under 35 U.S.C. §119 from European Patent Application No. 1309484.2 filed May 28, 2013, the entire contents of which are incorporated herein by reference.

### BACKGROUND OF THE INVENTION

1. Field of the Invention

This invention relates generally to the field of deduplication. More particularly, the invention relates to a deduplication system and method for use with linear storage mediums.

2. Description of Related Art

As data volumes to be stored and industry trends like “big data” are omnipresent, it has become popular to deduplicate data to be stored on longer term storage media, like hard disks or storage tapes. Basically, deduplication denotes a technology to store data segments, even if they belong to different data objects, only once and access them again using a more sophisticated index structure.

When the existing deduplication algorithms are directly applied to tapes as the primary deduplication target, the resulting layout of the data on the tapes typically incurs very long reading times for a single or for multiple files. Alternative existing solutions deduplicate data on disks with the disk's space being organized in so-called containers; then each container is separately moved to the tapes (D2D2T, i.e., Disk to Disk to Tape solutions). With such solutions, rehydrating a file spanning one or multiple containers may require prefetching the complete container, or containers involved, which may be an inefficient, multi-step and expensive operation.

There are several disclosures related to a method for deduplication. United States Patent Application No. 2013/0018854 describes a technique for routing data for improved deduplication in a storage server cluster. The technique includes computing, for each node in the cluster, a value collectively representative of the data stored on the node, such as a geometric center of the node. New or modified data is routed to the node which has stored data identical or most similar to the new or modified data, as determined based on those values.

U.S. Pat. No. 8,209,508 describes a method and system for data deduplication. It may utilize a data deduplication system that retrieves data from a data storage device in an order based on the location of blocks on the data storage device. Some embodiments break a data stream into multiple blocks of data and store the blocks of data on a data storage device of a data deduplication system, wherein a code representing a redundant block of data is stored in place of the block of data. A location for each block of data may be stored. Additionally, the blocks may be read in an order that is determined based on the location of the blocks.

However, existing recent deduplication technologies focus on disk drives instead of storage tape systems. Disk-based optimization techniques may not be adequate for magnetic storage tapes because optimization may be done according to different parameters and algorithms. Thus, a need exists for deduplication technology for linear storage mediums, e.g., a storage tape.

### SUMMARY OF THE INVENTION

One aspect of the present invention provides a method for deduplication of data to be storable on a storage system. The method includes the steps of: segmenting a storage object into a plurality of data segments; generating a content similarity key indicative of a content of at least one of the plurality of data segments, the at least one of the plurality of data segments storable on the storage medium; associating a physical position on the storage medium for the at least one of the plurality of data segments with the content similarity key to produce an association; storing the association in deduplication index information; and using the association for optimizing the deduplication, wherein data segments are selected to be deduplicated and the physical location on the storage medium where the data segments are written during the deduplication is selected.

Another aspect of the present invention provides a deduplication system for deduplicating of data to be storable on a storage medium. The deduplication system includes: a segmentation unit adapted for segmenting a storage object into a plurality of data segments; a generation unit adapted for generating a content similarity key indicative of a content of a data segment, the data segment storable on the storage medium; an associating unit adapted for associating a physical position on the storage medium for the data segment with the generated content similarity key, thereby producing an association; a storage unit adapted for storing the association in deduplication index information; and a deduplication optimization unit adapted for using the association for optimizing the deduplication, wherein data segments to be deduplicated are selected and the physical location on the storage medium where the data segments are written during the deduplication is selected.

Yet another aspect of the present invention provides a computer storage system for deduplication of data to be stored on a storage medium. The computer storage system includes: a memory; a processing device communicatively coupled to the memory; and a deduplication module communicatively coupled to the memory and the processing device. The deduplication module is configured to perform the steps of a method comprising: segmenting a storage object into a plurality of data segments; generating a content similarity key indicative of a content of at least one of the plurality of data segments, the at least one of the plurality of data segments storable on the storage medium; associating a physical position on the storage medium for the at least one of the plurality of data segments with the content similarity key to produce an association; storing the association in deduplication index information; and using the association for optimizing the deduplication, wherein data segments are selected to be deduplicated and the physical location on the storage medium is selected where the data segments are written during the deduplication.

The present method and systems for deduplication offer several advantages over existing methods and systems: firstly, there are advantages for storing data long-term on a magnetic tape instead of a hard disk. Here, it can be generally assumed that a tape is a magnetic tape. A tape is an important integral part of modern hierarchical storage systems. Tape-based storage is especially suitable for backup and archiving systems, because it is able to provide a low-cost (up to 20 times cheaper than disk) and a low-power (up to two orders of magnitude less power consumption than disk) storage. The data written to a tape is expected to be still readable from the media after few decades (30+ years).

Recently, the tape is being also integrated into tiered storage systems aimed to serve as active archives with significantly higher frequency and amount of file reads compared to the traditional archives. Also recently, the LTFS (Linear Tape File System) has been standardized allowing tapes to be accessed for writes and reads via a standard POSIX compliant file system interface. LTFS is widely accepted and implemented by multiple storage software providers and by major tape storage manufacturers and also free implementation versions are available. This suggests that software for reading LTFS tapes is likely to be available within decades.

Secondly, the present invention is advantageous because LTFS allows an extension of that standardized format such that additional information can be stored in the index information compared to the pure standardized version.

Thirdly, another advantage of the deduplication technique of the present invention can be seen in less read accesses to the tape because data segments can be grouped as extents and in addition, data segments and/or extents can be stored close to each other on the tape in a controlled and not a random way. Using physical positions as index information instead of logical position information in the index information enhances reading speed of stored data.

From the perspective of file reading time optimization, each file should be written to a tape at one location, meaning that the complete file would be appended to the tape even upon small edits to the file. However, the fact that a file may consist of multiple file extents, spread over a tape, may be important to consider expected file access times. If a single file can be read sequentially in its entirety, the total reading time is typically much shorter for a single extent file than for a file with multiple extents. Having multiple extents will cause repositioning the tape, possibly multiple times, which might significantly increase the time required to read the complete file. The present invention allows much better reading time by grouping extents during a deduplication when writing the data to the magnetic tape.

Hence, both may be achieved—a good deduplication ratio and a reasonably short reading time, i.e., fast access when reading one or multiple files from the tapes. Such a behavior is not achieved jointly with existing deduplication solutions.

As mentioned, the present invention can be implemented within a tape file system such as LTFS, or within a backup, archiving, or data migration application that writes files to tapes in LTFS format. The latter is especially advantageous, because a better optimization can be done in the deduplication algorithm—because typically multiple files are backed up, archived, or migrated, so the timing constraints can be more relaxed than in the case of a transparent implementation within a tape file system that needs to present a standard file system interface and process the file system calls in a timely manner.

### BRIEF DESCRIPTION OF THE DRAWINGS

FIG. 1 shows a block diagram of a method for deduplication of data to be stored on a storage system.

FIG. 2 shows a detailed block diagram a method for deduplication of data to be stored on a storage system.

FIG. 3 shows consecutive data segments of a data object.

FIG. 4 shows data segments of a data object grouped into extents and written or deduplicated to the storage medium.

FIG. 5 shows a block diagram of a deduplication system.

FIG. 6 shows a block diagram of a computing system comprising the deduplication system.

### DETAILED DESCRIPTION OF THE PREFERRED EMBODIMENTS

In the context of this description, the following conventions, terms and/or expressions are used:

The term “deduplication” denotes a compression technique of information to be stored on storage media, e.g., hard drives or magnetic storage tapes, magnetic tapes or, in short, tapes. The technique can be used for eliminating duplicate copies of repeating data. Typically, larger files to be stored may be cut into chunks of data. In files containing very similar data, there may be chunks that are identical. These may only be stored once on the storage medium. The cutting into data chunks or data segments can be performed using various algorithms.

The term “storage system” denotes a system adapted to store data. It can, for example, be a tape or any other storage medium on which data can be stored in a linear way. Related storage systems may store the data on magnetic tapes. The tapes can come in various forms, like classical “loose” tapes or, tapes within cartridges. Hence, a storage system can include a tape drive. A storage system can also be a tape drive or a storage library equipped with tape media. The storage system can be implemented with, but also without, a complete computing system.

The term “storage object” denotes any object that can be stored on a long-term storage medium. In one embodiment, the storage object can be a file. It can contain any type of digital information.

The term “content similarity key” denotes a data value generated out of a data segment of a storage object. In particular, the content similarity key can be generated by a hash function or hash algorithm, delivering a hash value for the assigned data segment. If the content similarity keys of two data segments are identical, the associated data segments can contain the same data and only one copy of the data segment may need to be stored once. For the other occurrence of a data segment, index information can be used in order to reconstruct—in a so-called rehydration process—an original file or data object including those assigned data segments.

In this context, the term “rehydration” denotes a reconstruction of deduplicated data. Data segments and index information can be used to rebuild an original file.

The term “storage medium” denotes any medium adapted to store data, in particular, a medium with the capability to store data over a longer period of time. In this context, a storage medium can be a magnetic tape. However, the described algorithms can also apply to other storage media and systems for sequentially storing data.

The term “physical position” denotes a set of parameters indicative of a position of a storage medium; in particular, a volume/tape identifier, a longitudinal position of stored data relative to the physical beginning of the tape (in particular, the beginning of the stored data on tape), a wrap number, a data segment or data chunk size in bytes or in longitudinal distance units.

The term “deduplication index information” denotes information about data segments that can be stored once on a storage medium, but that can belong to two or more different data objects, like files.

The term “new data segment” to be stored denotes a data segment that may have to be stored newly onto a magnetic tape because it may belong to a data object that can be stored.

The term “physical proximity” is used in the context of data segments to be stored on a storage tape. It can be defined by one or more threshold values. Each stored data segment can have a physical position on the tape. “Physical proximity” of the physical position of stored data segments can be reached if the tape does not have to be moved “too much” relative to the read/write head of a related tape drive between reading of two data segments of the data objects. The “too much” can be defined by a threshold value. Typically, the read/write head may switch fast between different tracks, or it may read different tracks of the tape simultaneously. Thus, physical proximity can also be reached if two data segments can be stored in an environment of a physical position on the tape relative to the beginning of the tape but on different tracks or wraps.

The term “buffering” denotes storing data intermediately, in particular temporarily or, for a limited time only. The buffering bridges a time between a decision to store data and the time of actual writing the data to a storage medium.

The term “current medium position” denotes a position of the tape that is related to the position of a read/write head of a related tape drive. A read/write head can read from and/or write to a position of the magnetic tape at the current medium position.

The term “extent” denotes a consecutive group of data segments of a data object, e.g., a file. If data objects are cut into chunks or data segments for, e.g., storing the file, it may be advantageous to group some data segments again to form larger chunks of data which may be called extents. This grouping allows for a faster read and/or write of the data because they can be read or be written in one step instead of being collected from positions spread all over the tape (in the case of a ‘read’). It should be noted that an extent can also include only one data segment.

The term “local deduplication index” denotes an index comprising information about positions of data segments belonging to data objects. The addition “local” denotes an index that may be related to a single storage medium, e.g., a single tape. Such local deduplication indexes can be stored on the tape itself. However, larger storage libraries can include a plurality of tapes. Data segments of a single data object can be scattered across different magnetic tapes. In contrast, a global deduplication index relates to a plurality of magnetic tapes. Here, it is also referred to as “common deduplication index”.

The term “Linear Tape File System format” (LTFS) denotes the standards based storage format and refers to both, the format of data recorded on a magnetic tape medium, and the implementation of specific software that uses this data format to provide a file system interface to data stored on magnetic tapes. The LTFS format is a self-describing tape format. The LTFS format specification, which was adopted by the LTO (Linear Tape-Open) Technology Provider Companies, defines the organization of data and metadata on tape, in particular, files stored in hierarchical directory structures. Data tapes written in the LTFS format may be used independently of any external database or storage system allowing direct access to file content data and file metadata. A standard POSIX (Portable Operating System Interface) compliant interface may be used for accessing the stored data objects.

A LTFS formatted tape typically consists of two partitions, an index partition and a data partition. The index partition can store the LTFS file system metadata, including pointers, in form of logical addresses (block number, offset, size), to the actual file data which is written onto the data partition. A file can consist of extents, each of which may be written to the magnetic tape using a continuous sequence of logical and physical blocks. Different extents from a file can be written at different longitudinal positions (positions along the tape length) and at different wraps (lateral tape positions).

The term “wrap” can denote different tracks on a magnetic tape. A tape can be divided into multiple parallel tracks that are written in a serpentine way—a wrap can be written while moving the tape in one direction over the tape length, then the next wrap can be written while rewinding the tape in the opposite direction until the other end of the tape. While longitudinal positioning to a random location typically may take long, e.g, 10s of seconds, positioning to a random wrap may typically be much faster.

The term in “physical medium position” is defined as the physical position on the tape with respect to a read/write head of a storage system, in particular, a tape system in the LTFS format.

According to one embodiment of the method of the present invention, a new data segment to be stored on the storage medium can be stored on the storage medium if the content similarity key of the new data segment is different to any content similarity key of a data segment already stored on the storage medium. This technique can help in deduplication of data segments such that only different data segments are physically stored. An identical content similarity key can indicate that the associated data segment has identical content. Thus, it may not be required to store the data segment a second time on the storage medium. Each content similarity key can be stored with the physical position of the assigned data segment inside the deduplication index.

Furthermore, the method can include associating a physical position on the storage medium for the data segment with the generated content similarity key, and storing the association in deduplication index information, in particular a deduplication index. This index may also be used during an optimized read of the stored data segment of the data object.

According to another embodiment of the method of the present invention, a new data segment to be stored on the storage medium can be stored in physical proximity of another data segment of the storage object already stored on the storage medium. In this embodiment, the new data segment can be part of the storage object, in particular, a complete file. This can reduce reading and writing times of complete data objects. Because data objects can be read in a sequential order and knowing the physical positions of the data segments of a data object, a fast reading process can be achieved.

The same can happen for a new extent to be stored on the tape as the same advantages apply. A reading process may be even faster, because an extent groups a series of consecutive data segments.

According to another embodiment of the method of the present invention, consecutive data segments of the data object can be grouped and stored together as an extent on the storage medium. The building of the extent or the selection of data segments that can be grouped into an extent which may be deduplicated can be based on at least one of: a physical position of the data segment to be grouped together; a number of data segment or extents to be grouped together; and a total number of extents of the data object.

Furthermore, the method uses the stored association for improving and/or optimizing the deduplication by selecting the data segments to be deduplicated and selecting the physical location on the storage medium where data segments are written during the deduplication.

In contrast to known deduplication techniques, embodiments of the present invention teach using the physical location information from the index for determining which data segments will be joined into extents, and which extents will be deduplicated.

In one embodiment, the total number of file extents can be limited, as to provide fast access for reading the entire file sequentially or in an optimized manner.

In another embodiment, the subsequent extents—regarding the file byte range they contain—can be written in physical proximity of each other, while the distance between the non-subsequent file extents can be allowed to be larger.

In another embodiment, the extents to be deduplicated can be formed and selected as to maximize the amount of data to be deduplicated under the constrained number of file extents allowed. Thus, a variety of different options reflecting the purpose of the deduplication is available for a storage optimization designer.

According to a further embodiment, an extent being part of the storage object can be stored in physical proximity of one or more other extents of the storage object already stored on the storage medium. Again, this may speed up the reading time of complete storage objects on, e.g., a storage tape. The advantages achieved with this technique can be the same if compared to the case of writing a data segment in physical proximity of other data segments. However, because an extent can include several grouped data segments, reading of extents being stored in physical proximity may be faster relative to un-optimized storing data on tape.

In one embodiment of the method, the new data segment to be stored on the storage medium can be buffered. In particular, the new data segment to be stored on the storage medium can be stored temporarily until a current storage medium position can reach a position that allows the storing of the new data segment in the physical proximity of the other data segment of the storage object on the storage medium. The same can apply for new extents to be stored on the tape.

Such a buffering in a temporary data segment storage or extent storage can allow for storing of data segments, or extents, to be postponed until a condition is reached, e.g., being able to store a new data segment or a new extent in a physical proximity of other data segments or extents. It can also allow optimizing the storage of data according to a limited number of extents a data object may be split into. Such a buffering can also enhance the writing time to the storage medium, because no wait for the “right” position of the storage medium, e.g., the tape, may be required.

Again, according to at least one embodiment of the method, the physical proximity is reached if a physical distance between the physical position of the new data segment or extent, respectively, and another data segment or extent, respectively, of the data object, is below a predefined threshold value in respect to a longitudinal position on the storage medium. Additionally, other parameters like a tape identifier (tape ID) or the number of a track, or wrap on a tape, can be instrumental for describing the physical proximity.

It should be noted that the physical proximity is not only measured in a longitudinal distance within a wrap, but also goes cross wraps. Thus, because two extents can be on different wraps, they can have, from a longitudinal perspective, a long distance between them—exactly one tape length if adjacent wraps are involved and the measurement is only made along the natural reading sequence of a tape—however, if the wrap is omitted, the extents may be very close, but only on different wraps.

In one specific embodiment of the method, the new data segment can be stored outside the proximity of the other data segment of the storage object already stored on the storage medium if the current medium position may not have reached the proximity of the other data segment of the data object and a predefined first threshold of the buffer time has been exceeded. This feature can allow for a balanced writing time required for new data segments. The threshold can be set in wide ranges to accommodate different timing requirements. Alternatively, the new data segment may be stored outside the proximity of other data segments of the storage object already stored if a usage of a temporary storage buffer may have exceeded a buffer capacity threshold. Obviously, a full buffer may not be able to buffer additional data. Thus, it may be advantageous to buffer only as long as enough buffer space is available. The buffer threshold can be set dynamically according to a buffer size and typical data segments to be stored.

According to an embodiment of the method, the complete storage object, composed of all its data segments and/or all extents, can be stored as one extent onto the storage medium if the actual medium position may not have reached the proximity of other data segments or extents of the data object within a predefined second threshold of the buffer time, or a predefined buffer capacity has exceeded. This means that all chunks or data segments of the data objects grouped into one extent, in particular, one stream of data bits can be written in one step, one go respectively, into a consecutive stream of data to the tape. This may be seen as an exceptional situation in a deduplication context. However, time constraints during writing processes to the tape may require such a technique. A use case for such a scenario may be a case in which a tape library can be used instead of a single tape and other extents of the data object can be deduplicated only with extents from other tapes that may require a long loading time.

According to another embodiment of the method, a local deduplication index, in particular, stored on one tape, can be joined into, or added to a common deduplication index, in particular one that spans several storage media or tapes. In addition, the local deduplication index may be extracted out of the common deduplication index and/or re-created out of data segments, or in particular, extents stored on the storage media. In particular, the extents may be split into data segments again and content similarity keys may be re-created. Also metadata, in particular file system metadata of storage objects stored on the storage medium, may be reflected when re-creating the local deduplication index. This is one advantage of self-contained data formats for the storage media.

In one embodiment of the method, a determination on which storage medium out of a plurality of storage medium the new data segment is stored is based on the common deduplication index information. Also here, the above explained proximity approach can be applied. If a file or data object is too large to be stored on one tape, one or more data segments of the data object may be stored on another tape. Physical handling tapes may also be very time consuming. In a robot-operated tape storage system, a special organization of tapes may apply. The special organization reflecting access times to data and the specific tape to store the new data segment may be put in correlation.

In embodiments of the method, the storage medium can be a magnetic tape using the Linear Tape File System (LTFS) format for storing data segments joint into extents. The advantages of the LTFS format have been mentioned above already. In a nutshell: It may be expected that for a long time in the future devices, i.e., tape drives, may be available to read the LTFS format. Data tapes written in the LTFS format may be used independently of any external database or storage system allowing direct access to file content data and file metadata. A standard POSIX compliant interface may be used for accessing the stored data objects.

In a particular embodiment of the method, the physical position, in particular a tape identifier, a longitudinal position relative to the beginning of the tape, a wrap number, a data size of the data segment can also be included into the Linear Tape File System index data stored on the storage medium. This can allow an optimized reading process compared to a standard LTFS reading procedure. The LTFS format does allow such user defined extensions without compromising the standard functionality of the LTFS format.

In a further embodiment of the method, the data segments being parts of one or multiple data objects can be read in an order according to their physical position instead of their logical position as being performed in a way a skilled person would approach the problem. The information about the physical position of the data segments can be stored as custom information of the Linear Tape File System index data. If compared to the standard way, this may speed-up the reading process significantly.

Furthermore, embodiments can take the form of a computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

The computer-readable medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

It should also be noted that embodiments of the invention have been described with reference to different subject-matters. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

In the following, a detailed description of the figures will be given. All instructions in the figures are schematic. Firstly, a block diagram of an embodiment of the inventive method for deduplication is given. Then further embodiments of a deduplication system are described.

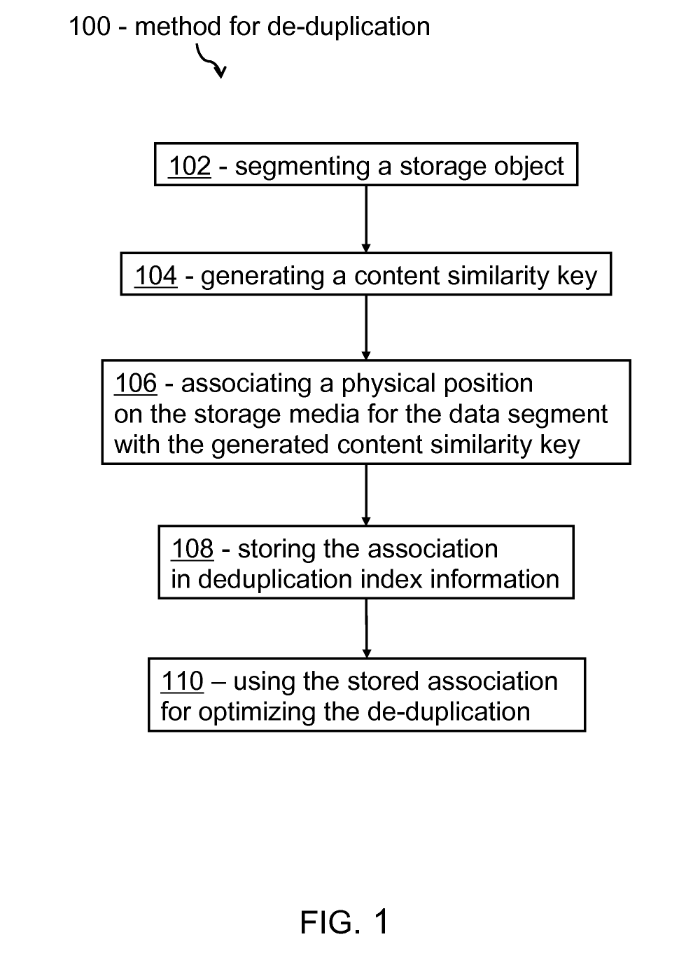

FIG. 1 shows a block diagram of an embodiment of the method 100 for deduplication of data to be stored on a storage system. The method includes segmenting a storage object at 102, in particular, a file or data object to be storable into a plurality of data segments which can also be denoted as data chunks. The method 100 includes generating a content similarity key indicative of a content of a data segment assigned at 104. In particular, the content similarity key can be generated by applying a hash function to a related data segment. The data segment can be storable on a storage medium, in particular a magnetic tape or other storage medium with serially organized data.

In a further step, the method 100 includes at 106, associating a physical position, e.g., a volume or tape identifier, a longitudinal position relative to beginning of tape, a wrap number, a data segment or chunk size in bytes or in longitudinal distance units—on the storage medium for the data segment with the generated content similarity key.

In a further step, the method includes storing the association in deduplication index information at 108, in particular for use by deduplication functionality or rehydrating of deduplicated data.

Finally, the method 100 at 110 includes using the stored associations for optimizing the deduplication, in particular, the deduplication writing and reading processes by selecting the data segments to be deduplicated and selecting the physical location on the medium where data segments or, specifically, the extents are written during the deduplication.

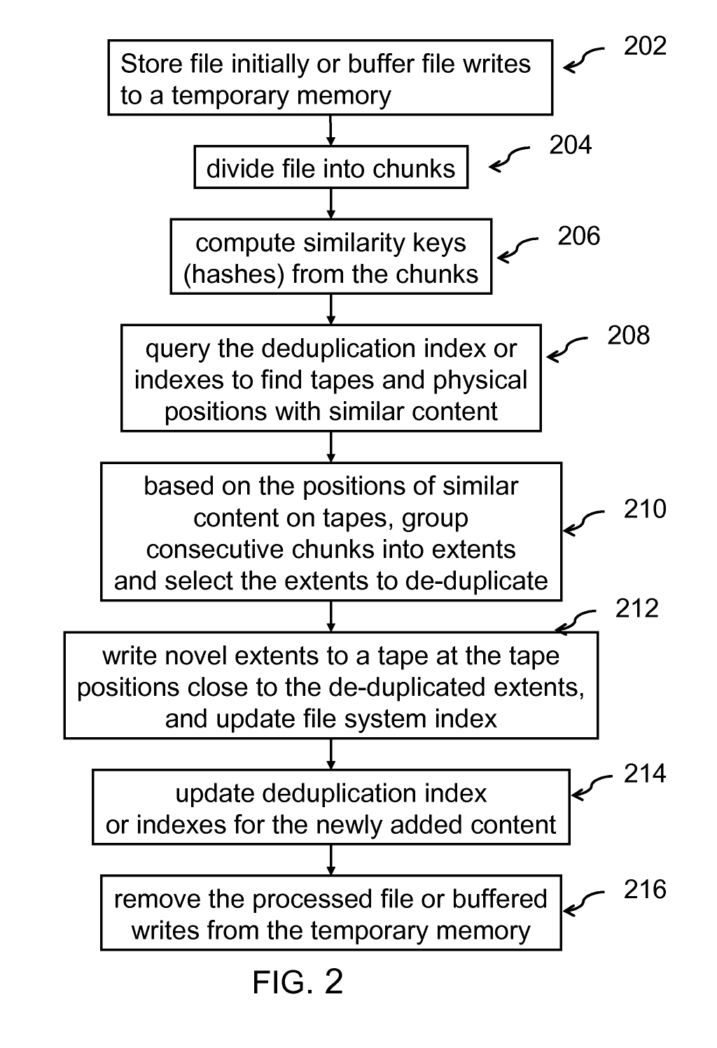

FIG. 2 shows a block diagram of an embodiment of the inventive method in more detail and with context information.

At step 202, file or storage object writes can be accepted through an LTFS file system interface, in which case the storage object can initially be stored into a temporary memory or data writes and be buffered. Initially, the storage object can typically be considered ‘dirty’ and not available for reads, until the temporary content can be processed, i.e., deduplicated and then the storage object state can be set to normal. The temporary storing or buffering can be done for a storage object part before the next steps can be applied for that part, or the entire storage object can be stored or buffered and the next steps triggered upon storage object or file close.

Alternatively, the storage object can be written to and accessed from a disk based file system, and the file data can be migrated to LTFS tapes and stored in form of LTFS files by a separate process that can be able to deduplicate the content.

At step 204, the storage object is divided into chunks or data segments based on its content or not. Typically, the chunking can be based on the content and similar storage objects can be split into identical or similar data segments.

At step 206, each data segment can be represented by a hash value, and the hash values from all the stored data segments form a standard deduplication index that may allow checking if a data segment from a new storage object can be novel or stored already. If the data segment can be stored already it can then be deduplicated. A file system index or a dedicated rehydration index can be updated to point to the already stored data segment, instead of storing and pointing the new data segment, thus, allowing for the restoring of the storage object from its parts, i.e., data segments.

Instead of using a simple hash function to enable finding identical data segments, a more complex similarity encoding representation can be used in step 206 in order to enable finding identical data segments. Similarity key can be the generic term used for denoting hash or more complex similarity encoding information used to form the deduplication index, e.g., data segment size can be larger and multiple hash values can be computed from the data segment, then one or multiple of those hash values can be selected according to a predefined algorithm to form the content similarity key.

Optionally, a previously stored segment corresponding to a similarity key can be read and a byte-by-byte comparison can be performed for verifying if the contents of a new data object segment and a previously stored data segment are indeed identical. This can be used to avoid improbable but possible false determination of identical segments due to imperfectness of the used hash function or similarity encoding representation.

Optionally, the similarity key can be used for finding similar rather than identical segments, and an additional processing can be used, that includes reading a previously stored segment, to identify and deduplicate the parts of a new data object segment that are identical to the parts of a previously stored similar data segment.

At step 208, known deduplication algorithms typically query the deduplication index in order to find out if a data segment or a data object part may already be stored and if it can be deduplicated. In some cases, this check can provide a probabilistic result, and the content similarity key needs to be checked or further determined. For that purpose, the logical addresses of the stored content are also stored in the deduplication index, in form of block numbers, offsets, and byte counts.

Certain embodiments of the present invention change this step qualitatively so to enable the determining of the physical location of the stored content. In addition to storing the hash values and logical addresses of data object content, the physical locations on the storage medium, such as tape longitudinal position and wrap number, can also be stored. This physical location information can be used to find out on which tape and at which physical location a similar content may be present.

At step 210, known deduplication algorithms can group the similar data segments. This is typically based on the logical continuity of their content, independent from the physical locations of the data segments or storage object parts on the storage medium.

Embodiments of the present invention teach using the physical location information from the index for determining which data segments can be joined into larger data object parts, called extents, and which extents can be deduplicated. In a preferred embodiment, the extents to deduplicate can be formed and chosen, so that they may not be very distant from each other.

In another embodiment, the total number of file extents can be limited. This provides fast access for reading the entire file sequentially or in an optimized manner.

In yet another embodiment, the subsequent extents (regarding the data object byte range they contain) can be written in physical proximity of each other, while the distance between the non-subsequent data object extents can be allowed to be larger. In another preferred embodiment, the extents to be deduplicated can be formed and selected, so to maximize the amount of data to be deduplicated under a constrained number of file extents allowed.

At step 212, standard deduplication solutions typically write data segments or extents as soon as the data segments or extents to be deduplicated are determined. With embodiments of the present invention, writing of the extents to a slow to position storage medium, such as LTO tape accessed via the LTFS file system, is postponed whenever needed and possible to be performed once the storage medium, e.g., a storage tape, can be positioned such that the longitudinal distance between the subsequent extents can be below a threshold value.

It should be understood that such a mechanism is especially feasible and important when writing to LTO tapes, because the writing process is performed in the ‘append only’ manner and the tape position is always changed in a serpentine like trajectory when writing. ‘Serpentine like’ means that the tape can be moved from one end to the other end, the wrap is changed, and then the tape can be moved to the end in opposite direction. The threshold distance rule is especially feasible to satisfy if the multiple files are processed for deduplication in parallel, in which case a joint list of pending extents to be written can be formed for multiple files, and the best matching extent can be selected to be written next.

Step 210 can also be processed jointly for multiple files for an additional optimization of the deduplication ratio and inter-extent distance. In implementations that pose time or temporary memory constraints, writing can be forced before the distance threshold is achieved, but the average distance between the extents is still lowered. Upon writing an extent to the storage medium, typically a rehydration index or a file system index can be updated as to allow restoring a file from its parts, i.e., data segments when the file is accessed for reading.

With the present invention, in a preferred embodiment, the deduplicated data objects can be written in a standard LTFS format, by referencing the extents from the LTFS index, and thus allow reading of the files from the tapes without any dependence on the deduplication process metadata.

At step 214, whenever a new data segment can be written to a tape, an entry can be added to the deduplication index that is composed of: hash value of the data segment, known also as a similarity key; the logical block number, offset and byte range of the data segment—when data is stored in LTFS format, this can be optional and used when a byte-by-byte comparison and verification can be used during deduplication, otherwise this information may also be needed and used for rehydration of data; a physical position of the data segment in terms of longitudinal position and wrap number, where the wrap number is also optional; and the tape name, if multiple tapes and a common deduplication index can be used.

Optionally, an identical data segment can be written to multiple tapes or multiple positions within a tape in order to guaranty inter-extent proximity, in which case a hash value can be paired with multiple tapes and positions within the tapes.

At step 216, once the data objects or its part that is temporarily stored or buffered is processed, the data object or the part is removed from the temporary storage or buffer.

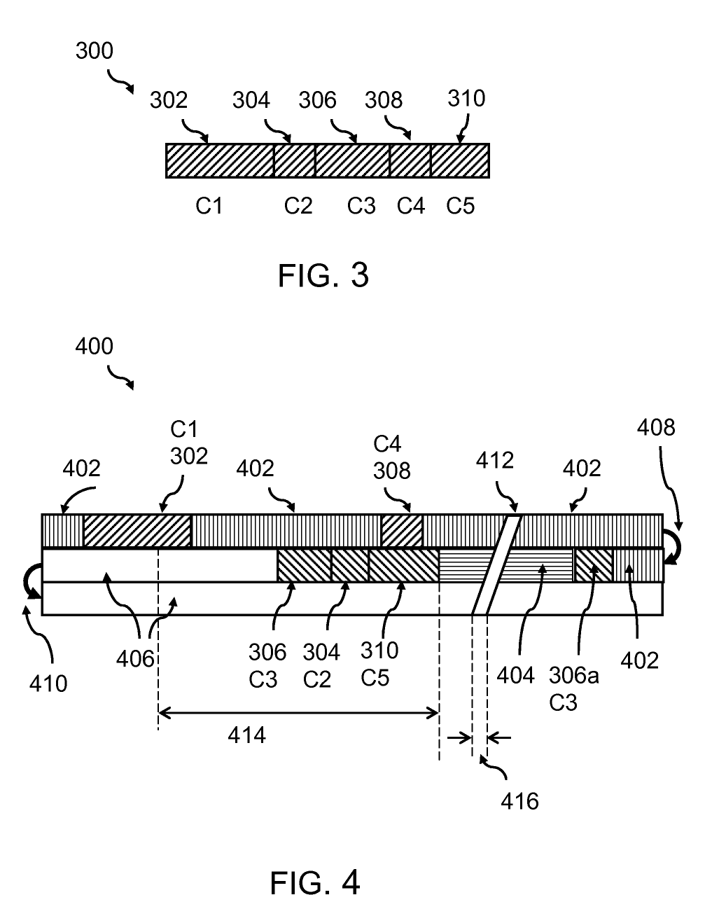

FIG. 3 shows data segments of data object 300. Data object 300 can be split into data segments C1, C2, C3, C4, C5 having reference numerals 302, 304, 306, 308, 310, respectively. A deduplication index can map content similarity keys, i.e., hash values of data segments 302, 304, 306, 308, 310, to physical locations on the storage media where the data segments can be stored. The physical location can be described, e.g., by tape, i.e., volume ID, longitudinal position relative to the beginning of the tape, a wrap number, a data segment size in bytes or in longitudinal distance units.

However, writing novel segments to the tape may not be sequential and may not be according to their order within data object 300.

Optionally, the target tape or tapes for data object 300 to be stored can be selected based on the number, size, and relative position of the matching data segments with matching similarity keys already stored on the tape or tapes. Additionally, the extents, i.e., groups of consecutive data segments 302, 304, 306, 308, 310 to be deduplicated, can be formed and selected by using the physical location information from the deduplication index to control the number and mutual distances of the file extents. As discussed, the writing-time, and the position on the tape for the novel—not deduplicated—extents can be determined using physical position on the media to control the mutual distances of the file extents.

FIG. 4 shows data segments of data object 300 grouped into extents and stored, or deduplicated on storage medium 400 according to an embodiment of the invention.

Storage tape or storage medium 400 can be selected as the file target because it can contain the most similar content to the data segments 302, 304, 306, 308, 310 that is also not much spread over storage medium 400. Large data segments, previously stored on storage medium 400 that may not be far from each other, can be selected to be deduplicated. These can, for example, be data segments C1 302 and C4 304. Data segment C3 306 could be deduplicated but may not be selected for deduplication because it has a large longitudinal distance from data segment C1 302 and data segment C4 308, so that data segment C3 306 can be written to storage medium 400 again.

Writing novel data segments C2 304 and C5 310, as well as C3 306 can be postponed if allowed by the write process timing constraints until the storage medium can be positioned, so that these data segments can be written at small longitudinal distance to the deduplicated data segments C1 302, C4 308 in order to provide short extent-to-extent seek time when reading data object 300 sequentially. In this example, data segments C2 304 and C3 306 can be written one after another, so to form a larger extent consisting of continuous bytes from the file. Data segment C5 may not belong to the same extent as data segments C2 and C3, because data segments C2, C3, and C5 do not form a continuous range of the data object 300 bytes.

Area 402 on storage medium 400 striped from top to bottom and data segments C1, C3, and C4 can be related to other data objects written to the storage medium 400 prior a request to write and deduplicate data object 300. Areas 404 on the storage medium 400 striped from left to right can be related to data objects written upon a request to write and deduplicate data object 300, but prior to writing non-deduplicated segments of data object 300. Areas with diagonal stripes can belong to data object 300, deduplicated or not.

Areas 406 may currently be empty, i.e., may not store any data yet. Moreover, reference numeral 408 denotes a wrap or track change, i.e., here, the information stored on storage medium 400 can be chained in a serpentine-like way from one track to another. Reference numeral 410 shows the next wrap change. Reference numeral 412 symbolizes that the actual tape length may be much longer in between the two parallel lines. As a consequence, data segment C3 306a would be far away from other data segments C1 302, C2 304, C4 308, C5 310 by large distance 416. In contrast, distance 414 between the outposts data segment C1 302 and the beginning of the data segment C5 310 may be much smaller. Hence, in this case, data segment C3 306 can be re-written instead of using already stored data segment C3 306a. This can be a consequence of the optimization process performed during the deduplication.

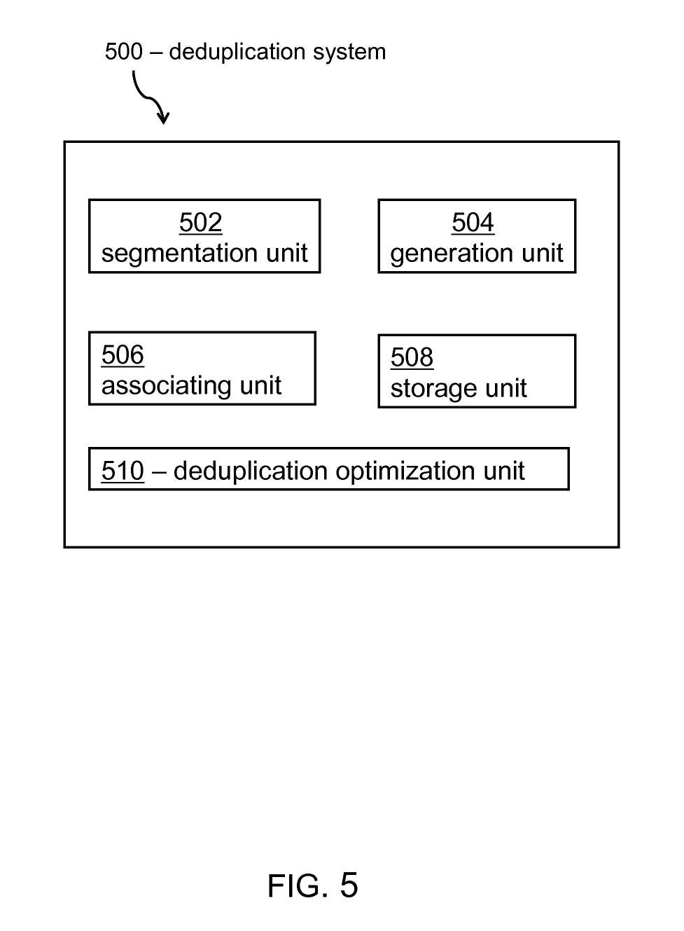

FIG. 5 shows a block diagram of deduplication system 500 that includes segmentation unit 502 adapted for segmenting a storage object into a plurality of data segments, and generation unit 504 adapted for generating a content similarity key indicative of a content of the data segment assigned, where the data segment can be storable on the storage medium.

Furthermore, deduplication system 500 includes associating unit 506 adapted for associating a physical position on the storage medium for the data segment with the generated content similarity key, and storage unit 508 adapted for storing the association in deduplication index information. Deduplication system 500 can also include deduplication optimization unit 510 adapted for using the stored association for optimizing the deduplication by selecting the data segments to be deduplicated, and selecting the physical location on the storage medium where data segments are written during the deduplication.

The system can also include an associating unit adapted for associating a physical position on the storage medium for the data segment with the generated content similarity key. There can also be a storage unit as part of the system, and it can be adapted for storing the association in deduplication index information. It should be noted that the deduplication index can also be stored on the storage medium, i.e., the magnetic tape.

It should be noted that memory as part of a computing server attached to the deduplication system can typically be used to store the deduplication index during the deduplication.

When not used, the deduplication index can be unloaded from the working memory to disks or tapes. Optionally, part of the deduplication index relevant for a tape could be extracted and stored to that tape, which can be done for some or all of the tapes, e.g., if the tape can be going to be exported from the system. This is simply done by extracting all the deduplication index entries containing that tape ID. This can be useful to do, for example, when a tape is full and cannot be used as a target for storing new content, and when file content must be stored within one tape which is the case with the LTFS standard. It should be noticed that the deduplication or a special rehydration index is not necessarily needed to read the data from tape, instead the tape file system index (LTFS in a particular embodiment) can be used. Also, if the tape is to become the target for deduplication at a later point in time, the deduplication index for that tape can be recreated by “chunking”, i.e., segmenting the files or data objects stored on the magnetic tape or storage tape, and creating an entry per unique data segment hash value, which, however, may require reading the full tape.

Adding such a tape index to the joint deduplication index means adding, or updating, the hash value entries in the joint index based on the hash value entries from the tape index.

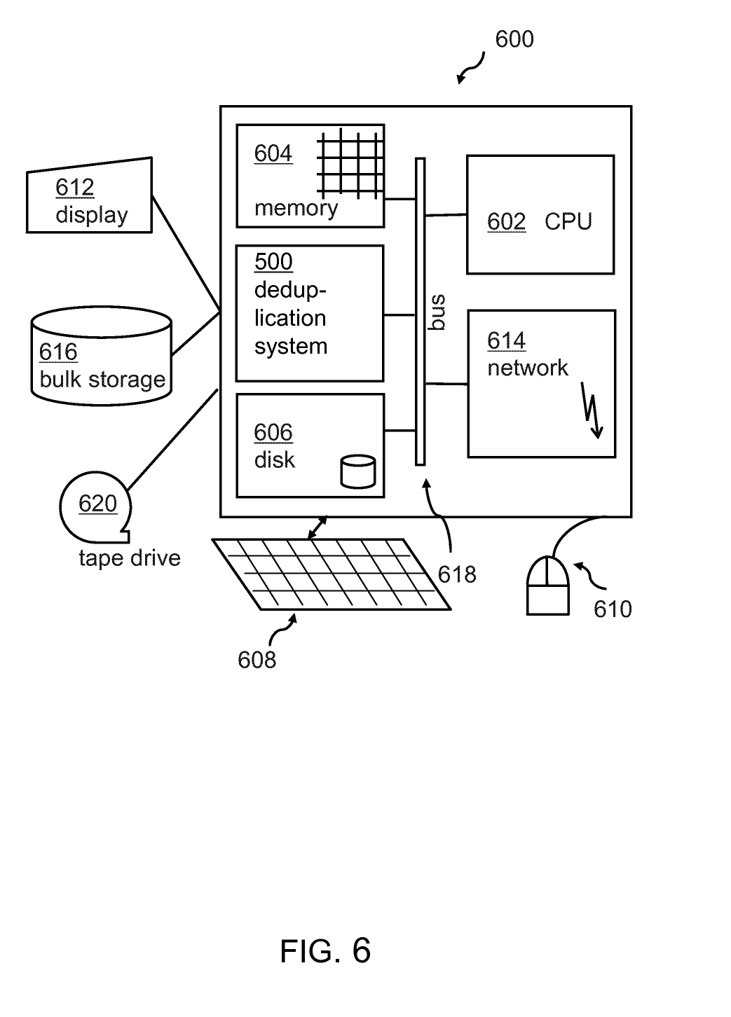

Embodiments of the invention can be implemented together with virtually any type of computer, regardless of the platform being suitable for storing and/or executing program code. For example, as shown in FIG. 6, computing system 600 can include one or more processor(s) 602 with one or more cores per processor, associated memory elements 604, internal storage device 606 (e.g., a hard disk, an optical drive such as a compact disk drive or digital video disk (DVD) drive, a flash memory stick, a solid-state disk, etc.), and numerous other elements and functionalities, typical of today's computers (not shown). Memory elements 604 can include a main memory, e.g., a random access memory (RAM), employed during actual execution of the program code, and a cache memory, which can provide temporary storage of at least some program code and/or data in order to reduce the number of times, code and/or data must be retrieved from a long-term storage medium or external bulk storage 616 for an execution. Elements inside computer 600 can be linked together by means of bus system 618 with corresponding adapters. Additionally, deduplication system 500 can be attached to bus system 618. However, the deduplication system may not necessarily be integrated into computer system 600. It can also be included into a tape drive system, such as tape drive 620.

Computing system 600 also includes input means, such as keyboard 608, a pointing device such as mouse 610, or a microphone (not shown). Alternatively, the computing system can be equipped with a touch sensitive screen as main input device. Furthermore, computer 600 includes output means, such as a monitor or screen, i.e., display 612 such as a liquid crystal display (LCD), a plasma display, a light emitting diode display (LED), or cathode ray tube (CRT) monitor.

Computer system 600 can be connected to a network (e.g., a local area network (LAN), a wide area network (WAN), such as the Internet or any other similar type of network, including wireless networks via network interface connection 614. This can allow a coupling to other computer systems or a storage network or tape drive 620. Those, skilled in the art will appreciate that many different types of computer systems exist, and the aforementioned input and output means can take other forms. Generally speaking, computer system 600 can include at least the minimal processing, input and/or output means, necessary to practice embodiments of the invention.

While the invention has been described with respect to a limited number of embodiments, those skilled in the art, having benefit of this disclosure, will appreciate that other embodiments may be devised, which do not depart from the scope of the invention, as disclosed herein. Accordingly, the scope of the invention should be limited only by the attached claims. Also, elements described in association with different embodiments may be combined. It should also be noted that reference signs in the claims should not be construed as limiting elements.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions, which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus provide processes for implementing the functions/acts specified in the flowchart and/or block diagram block or blocks.

The block diagrams in the Figures illustrate the architecture, functionality, and operation of possible implementations of systems, methods and computer program products according to various embodiments of the present disclosure. In this regard, each block in the block diagrams may represent a module, segment, or portion of code, which comprises one or more executable instructions for implementing the specified logical function(s). It should also be noted that, in some alternative implementations, the functions discussed hereinabove may occur out of the disclosed order. For example, two functions taught in succession may, in fact, be executed substantially concurrently, or the functions may sometimes be executed in the reverse order, depending upon the functionality involved. It will also be noted that each block of the block diagrams, and combinations of blocks in the block diagrams, may be implemented by special purpose hardware-based systems that perform the specified functions or acts, or combinations of special purpose hardware and computer instructions.

The terminology used herein is for the purpose of describing particular embodiments only and is not intended to limit of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiment was chosen and described in order to best explain the principles of the invention and the practical application, and to enable others of ordinary skills in the art to understand the invention for various embodiments with various modifications, as are suited to the particular use contemplated.

We claim:

1. A method for deduplication of data to be stored on a storage medium, the method comprising the steps of:
segmenting a storage object into a plurality of data segments;
generating a content similarity key indicative of a content of at least one of the plurality of data segments, wherein the at least one of the plurality of data segments is storable on the storage medium;
associating a physical position on the storage medium for the at least one of the plurality of data segments with the content similarity key to produce an association;
storing the association in deduplication index information; and
optimizing the deduplication by using the association,
wherein data segments to be deduplicated and the physical location on the storage medium where the data segments are written during the deduplication are selected.

2. The method according to claim 1, wherein a new data segment to be stored on the storage medium is stored on the storage medium if the content similarity key of the new data segment is different from the content similarity key of a data segment already stored on the storage medium.

3. The method according to claim 1, wherein a new data segment to be stored on the storage medium, and is part of the storage object, is stored in a physical proximity to a different data segment of the storage object already stored on the storage medium.

4. The method according to claim 1, wherein consecutive data segments of the storage object are grouped and stored together as an extent on the storage medium, wherein the building of the extent to be deduplicated is based on at least one selected from the group consisting of: a physical position of the data segment to be grouped together, a number of data segments to be grouped together, and a total number of extents of the storage object.

5. The method according to claim 1, wherein an extent to be stored on the storage medium, and is part of the storage object, is stored in a physical proximity of a different extent of the storage object already stored on the storage medium.

6. The method according to claim 3, wherein the new data segment to be stored on the storage medium is buffered until a current medium position reaches a physical position that allows storing of the new data segment in the physical proximity of the different data segment of the storage object already stored on the storage medium.

7. The method according to claim 5, wherein the extent to be stored on the storage medium is buffered until a current medium position reaches the physical position that allows storing of the extent in the physical proximity of the different extent of the storage object already stored on the storage medium.

8. The method according to claim 6, wherein the physical proximity is reached if a physical distance of the physical position of the new data segment, compared to the different data segment of the storage object, is below a predefined threshold value with respect to a longitudinal position on the storage medium.

9. The method according to claim 7, wherein the physical proximity is reached if a physical distance between the physical position of the extent and the different extent of the storage object already stored on the storage medium is below a predefined threshold value with respect to a longitudinal position on the storage medium.

10. The method according to claim 6, wherein the new data segment is stored outside the physical proximity of the different data segment of the storage object already stored on the storage medium if the current medium position has not reached the physical proximity of the different data segment of the storage object, and a predefined first threshold of a buffer time has been exceeded or usage of a storage buffer has exceeded a buffer capacity threshold.

11. The method according to claim 3, wherein the storage object, being composed of the plurality of data segments, is stored as one extent on the storage medium if an actual medium position has not reached the physical proximity of the different data segment of the data object and a predefined second threshold of a buffer time has been exceeded or a predefined buffer capacity has been exceeded.

12. The method according to claim 1, wherein a local deduplication index is added to and/or extracted out of the common deduplication index, and/or the local deduplication index is recreated out of the plurality of data segments and metadata of storage objects stored on the storage medium.

13. The method according to claim 12, wherein a determination of which storage medium out of a plurality of storage media the new data segment is stored is based on the common deduplication index information.

14. The method according to claim 4, wherein the storage medium is a magnetic tape using a Linear Tape File System format for storing the plurality of data segments joint into extents.

15. The method according to claim 14, wherein the physical position of the plurality data segments are included in Linear Tape File System index data stored on the storage medium.

16. The method according to claim 15, wherein the plurality of data segments being part of one or more storage objects is read in an order according to a physical position of one or more storage objects, wherein information about the physical position is stored as custom information of the Linear Tape File System index data.

17. A deduplication system for deduplication of data to be stored on a storage medium, the deduplication system comprising:
a segmentation unit adapted for segmenting a storage object into a plurality of data segments;
a generation unit adapted for generating a content similarity key indicative of a content of a data segment, the data segment storable on the storage medium;
an associating unit adapted for associating a physical position on the storage medium for the data segment with the generated content similarity key, thereby producing an association;
a storage unit adapted for storing the association in deduplication index information; and
a deduplication optimization unit adapted for using the association for optimizing the deduplication, wherein data segments to be deduplicated and the physical location on the storage medium where the data segments are written during the deduplication are selected.

18. A computer storage system for deduplication of data to be stored on a storage medium, the computer storage system comprising:
a memory;
a processing device communicatively coupled to the memory; and
a deduplication module communicatively coupled to the memory and the processing device, wherein the deduplication module is configured to perform the steps of a method comprising the steps of:
segmenting a storage object into a plurality of data segments;
generating a content similarity key indicative of a content of at least one of the plurality of data segments, the at least one of the plurality of data segments storable on the storage medium;
associating a physical position on the storage medium for the at least one of the plurality of data segments with the content similarity key to produce an association;
storing the association in deduplication index information; and
using the association for optimizing the deduplication, wherein data segments are selected to be deduplicated and the physical location on the storage medium is selected where the data segments are written during the deduplication.

19. A computer readable non-transitory article of manufacture tangibly embodying computer readable instructions which, when executed, cause a computer to perform the steps of a method according to claim 1.
